(19) United States
(12) Patent Application Publication
(10) Pub. No.: US 2024/0340762 A1
(43) Pub. Date: Oct. 10, 2024

(54) REMOTE-RELAY FLOW MAPPING INFORMATION DELIVERY

(71) Applicant: Nokia Technologies Oy, Espoo (FI)

(72) Inventors: Ling YU, Espoo (FI); SunYoung LEE, Seoul (KR); Faranaz SABOURI-SICHANI, Aalborg (DK); Vinh VAN PHAN, Oulu (FI); György Tamás WOLFNER, Budapest (HU); Jakob Lindbjerg BUTHLER, Aalborg (DK)

(21) Appl. No.: 18/623,592

(22) Filed: Apr. 1, 2024

(30) Foreign Application Priority Data
Apr. 4, 2023 (GB) 2304956.2

(51) Int. Cl. H04W 40/22; H04W 88/04

(52) U.S. Cl. CPC H04W 40/22; H04W 88/04

(57) ABSTRACT

A method may include receiving, from a network element over a first interface, configuration information comprising at least a trigger condition for transmission of a remote-relay flow mapping information. The method may also include determining when to transmit the remote-relay flow mapping information to the network element based on the configuration information. The method may further include transmitting, to the network element over the first interface, the remote-relay flow mapping information when the trigger condition is satisfied.

### FIELD

Some example embodiments may generally relate to mobile or wireless telecommunication systems, such as Long-Term Evolution (LTE) or fifth generation (5G) new radio (NR) access technology, or 5G beyond, or other communications systems. For example, certain example embodiments may relate to apparatuses, systems, and/or methods for remote-relay flow mapping information delivery.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving, from a network element over a first interface, configuration information comprising at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The method may also include determining when to transmit the remote-relay flow mapping information to the network element based on the configuration information. The method may further include transmitting, to the network element over the first interface, the remote-relay flow mapping information when the trigger condition is satisfied.

Other example embodiments may be directed to an apparatus. The apparatus may include at least one processor and at least one memory including computer program code. The at least one memory and computer program code may be configured to, with the at least one processor, cause the apparatus at least to receive, from a network element over a first interface, configuration information including at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The apparatus may also be caused to determine when to transmit the remote-relay flow mapping information to the network element based on the configuration information. The apparatus may further be caused to transmit, to the network element over the first interface, the remote-relay flow mapping information when the trigger condition is satisfied.

Other example embodiments may be directed to an apparatus. The apparatus may include means for receiving, from a network element over a first interface, configuration information including at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The apparatus may also include means for determining when to transmit the remote-relay flow mapping information to the network element based on the configuration information. The apparatus may further include means for transmitting, to the network element over the first interface, the remote-relay flow mapping information when the trigger condition is satisfied.

In accordance with other example embodiments, a non-transitory computer readable medium may be encoded with instructions that may, when executed in hardware, perform a method. The method may include receiving, from a network element over a first interface, configuration information comprising at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The method may also include determining when to transmit the remote-relay flow mapping information to the network element based on the configuration information. The method may further include transmitting, to the network element over the first interface, the remote-relay flow mapping information when the trigger condition is satisfied.

Other example embodiments may be directed to a computer program product that performs a method. The method may include receiving, from a network element over a first interface, configuration information comprising at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The method may also include determining when to transmit the remote-relay flow mapping information to the network element based on the configuration information. The method may further include transmitting, to the network element over the first interface, the remote-relay flow mapping information when the trigger condition is satisfied.

Other example embodiments may be directed to an apparatus that may include circuitry configured to receive, from a network element over a first interface, configuration information including at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The apparatus may also include circuitry configured to determine when to transmit the remote-relay flow mapping information to the network element based on the configuration information. The apparatus may further include circuitry configured to transmit, to the network element over the first interface, the remote-relay flow mapping information when the trigger condition is satisfied.

Certain example embodiments may be directed to a method. The method may include configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The method may also include receiving, from the first user equipment over the first interface, remote-relay flow mapping information when the trigger condition is satisfied. The method may further include transmitting, over the first interface, the remote-relay flow mapping information to a second user equipment.

Other example embodiments may be directed to an apparatus. The apparatus may include at least one processor and at least one memory including computer program code. The at least one memory and computer program code may be configured to, with the at least one processor, cause the apparatus at least to configure, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The apparatus may also be caused to receive, from the first user equipment over the first interface, remote-relay flow mapping information when the trigger condition is satisfied. The apparatus may further be caused to transmit, over the first interface, the remote-relay flow mapping information to a second user equipment.

Other example embodiments may be directed to an apparatus. The apparatus may include means for configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The apparatus may also include means for receiving, from the first user equipment over the first interface, remote-relay flow mapping information when the trigger condition is satisfied. The apparatus may further include means for transmitting, over the first interface, the remote-relay flow mapping information to a second user equipment.

In accordance with other example embodiments, a non-transitory computer readable medium may be encoded with instructions that may, when executed in hardware, perform a method. The method may include configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The method may also include receiving, from the first user equipment over the first interface, remote-relay flow mapping information when the trigger condition is satisfied. The method may further include transmitting, over the first interface, the remote-relay flow mapping information to a second user equipment.

Other example embodiments may be directed to a computer program product that performs a method. The method may include configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The method may also include receiving, from the first user equipment over the first interface, remote-relay flow mapping information when the trigger condition is satisfied. The method may further include transmitting, over the first interface, the remote-relay flow mapping information to a second user equipment.

Other example embodiments may be directed to an apparatus that may include circuitry configured to configure, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The apparatus may also include circuitry configured to receive, from the first user equipment over the first interface, remote-relay flow mapping information when the trigger condition is satisfied. In addition, the apparatus may include circuitry configured to transmit, over the first interface, the remote-relay flow mapping information to a second user equipment.

### BRIEF DESCRIPTION OF THE DRAWINGS

For proper understanding of example embodiments, reference should be made to the accompanying drawings, wherein:

FIG. 1 illustrates an example remote-relay flow and Uu relay RLC channel of a radio bearer over an indicated path.

FIG. 2 illustrates an example signal diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for remote-relay flow mapping information delivery.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably. Additionally, the terms broadcast, transmit, or other similar language, throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

In the technical specifications of the 3rd Generation Partnership Project (3GPP), for sidelink (SL) relay, a SL relay adaptation protocol (SRAP) entity may be placed above a radio link control (RLC) entity, and a bearer mapping may be handled between an end-to-end (E2E) radio bearer (RB) of a remote user equipment (UE) and the relay RLC channel over a Uu/PC5 interface. For instance, in uplink (UL), a remote user equipment (UE) may map an E2E RB to a PC5 (direct communications) relay RLC channel according to a bearer mapping configuration received from a gNB. The relay UE may identify the E2E RB for data received via the PC5 relay RLC channel according to a bearer identifier (ID) information in a PC5 SRAP header. Additionally, the relay UE may map the E2E RB to a Uu relay RLC channel according to the bearer mapping configuration received from the gNB. The gNB may identify the E2E RB for data received via the Uu relay RLC channel according to the bearer ID information in a Uu SRAP header.

In 3GPP, the SRAP entity in a remote UE may determine an egress RLC channel to transmit data to a relay UE based on certain information. For instance, the information may include field descriptions such as, for example, sl-EgressRLC-ChannelPC5 and sl-RemoteUE-RB-Identity, where sl-EgressRLC-ChannelPC5 may indicate the egress RLC channel on a PC5 hop, and the sl-RemoteUE-RB-Identity may identify the E2E bearer identity of an L2 U2N remote UE. The SRAP entity in the relay UE may determine an egress RLC channel to transmit data to a gNB based on information such as, for example, sl-EgressRLC-ChannelUu and sl-RemoteUE-RB-Identity, where sl-EgressRLC-ChannelUu indicates the egress RLC channel on the Uu hop. The necessary information may be configured via SL-SRAP-Config, which may be used to set configurable SRAP parameters used by a Layer-2 UE-to-network (L2 U2N) relay UE and a L2 U2N remote UE.

As described in 3GPP Rel-18, SL relay may operate in two scenarios. For instance, in scenario 1, the interface between the remote UE and the relay UE (i.e., remote-relay interface) may be based on 3GPP PC5. In scenario 2, the remote-relay interface may be assumed to be non-3GPP. In the case of scenario 2, radio access network 2 (RAN2) working group defines the relay UE as being restricted to serve only one remote UE. The UE identification in an L2 protocol data unit (PDU) over non-3GPP link may not be in 3GPP scope in scenario 2. Additionally, UE identification may not be needed over Uu link in scenario 2 if the relay UE serves only one remote UE and different Uu RLC channels may be assumed for the remote UE and the relay UE.

For scenario 2, different Uu logical channels may be configured for identification of data directed to/originating from the relay UE, and data relayed from/to the remote UE over the Uu link of the relay UE in indirect path. Without the adaptation layer over Uu link in scenario 2, a packet data convergence protocol (PDCP) PDU may be delivered to an intended PDCP entity or RLC entity for support of more than one RB over the Uu link. This may be accomplished by, for example, configuring a 1:1 bearer mapping and different Uu RLC channels configured for relay UE local traffic and relay traffic for PDU delivery. Bearer identification except logical channel ID (LCID) may not be needed in L2 PDU over the Uu link in scenario 2. Instead, only a 1:1 bearer mapping may be supported over the Uu link for an indirect path.

As the adaptation layer (i.e., SRAP entity) is not to be specified over the non-3GPP U2U interface on top of other lower layer entities, the relay UE may not be able to identify the UE ID and the RB ID based on the SRAP header for scenario 2. Since remote-relay flow mapping may occur over a non-3GPP interface, it may be necessary for the remote UE and the relay UE, by implementation to decide and share remote-relay flow mapping information. To achieve this, a control protocol between the two UEs may be needed. However, such a protocol may not be guaranteed by 3GPP, and its implementation may not be mandated since there is a non-3GPP interface in question. Thus, 3GPP may need to provide an alternative solution to exchange or deliver the remote-relay flow mapping information between the remote UE and the relay UE through the serving gNB when there is no SRAP entity available.

To address the issue of when there is no SRAP entity available, the remote-relay flow mapping information may be exchanged between the remote UE and the relay UE by transmitting/receiving the remote-relay flow mapping information via a (non-3GPP) remote-relay interface. However, the serving gNB may not be able to reassure or be reassured that the mapping will be in synch between the remote UE and relay UE, as intended. In other words, when the remote-relay interface is a non-3GPP link, it may not be possible for the network to know or configure the packet flow mapping to be ensured that the mapping is in synch between the remote UE and the relay UE. Additionally, when the remote-relay interface is a non-3GPP link, and there is no control plane (CP) interface available, it may not be possible for remote UE and relay UE to exchange the packet flow mapping information between them. Since the network may not use SRAP as it does not exist in this scenario, it may be desirable to have alternative approaches to identify the flow mapping. Thus, either the relay UE or the remote UE may determine this, and transmit it to the network, which may share the flow mapping to the other UE(s).

The gNB in UL needs to identify the remote UE and the corresponding RB ID of the received data relayed via the relay UE from the remote UE. If a SRAP entity exists, the gNB may identify the remote UE and the corresponding RB ID of the received data based on a SRAP header. Otherwise (if the SRAP entity does not exist), the gNB may need to identify the remote UE and the RB based on other means. If the SRAP entity does not exist, one possibility may be to use a logical channel ID (LCID) assuming that one relay UE serves only one remote UE, and a 1:1 bearer mapping is assumed between an E2E RB and Uu relay RLC channel (1:1 mapping between RB ID of E2E RB and LCID of Uu relay RLC channel).

For a 1:1 bearer mapping, the gNB may provide configuration information to the relay UE. For example, the configuration information may include sl-EgressRLC-ChannelUu and sl-RemoteUE-RB-Identity, which may be used over the relay UE's Uu link. However, the gNB may not configure the mapping between the E2E RB and a remote-relay flow between the relay UE and the remote UE because the mapping is to be used over non-3GPP remote-relay link. This mapping between the E2E RB and a remote-relay flow may be referred to as a remote-relay flow mapping, and it may be used for UL transmission by the remote UE to determine the egress remote-relay flow. The remote-relay flow mapping may also be used by the relay UE to identify the corresponding E2E RB. For DL transmission, remote-relay flow mapping may be used by the relay UE to determine the egress remote-relay flow, and may be used by the remote UE to identify the corresponding E2E RB.

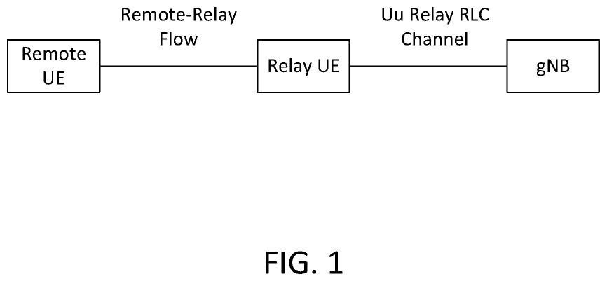

FIG. 1 illustrates an example remote-relay flow and Uu relay RLC channel of a radio bearer over an indicated path. As illustrated in FIG. 1, since the remote-relay flow mapping is a mapping between the E2E RB of remote UE and the remote-relay flow over a non-3GPP interface, the remote UE and the relay UE may need to decide and share the remote-relay flow mapping information. To achieve this, a control protocol between the two UEs may be needed. However, as described above, such a protocol may not be guaranteed by 3GPP, and its implementation may not be mandated. Thus, 3GPP may need to provide an alternative solution for exchanging or delivering the remote-relay flow mapping information between the remote UE and the relay UE through the serving gNB.

The remote-relay flow mapping information may be utilized by the remote UE and the relay UE, but not the network itself. However, in certain scenarios, it may be advantageous to store the remote-relay flow mapping information on the gNB side. For instance, storing this information in the gNB side may facilitate fast delivery of the remote-relay flow mapping information to the target relay UE by the gNB, instead of having the remote UE deliver it only after establishing remote-relay connection between the two UEs. For this, a new mechanism may be needed for either the remote UE or the relay UE to transmit the remote-relay flow mapping information to the gNB. However, currently, 3GPP does not provide a mechanism to deliver remote-relay flow ID mapping information via the gNB.

In view of the above, the remote UE or the relay UE in certain example embodiments may be connected via a non-3GPP interface, and may transmit remote-relay flow mapping information to the gNB via a Uu interface when the remote-relay flow mapping information cannot be exchanged directly over a non-3GPP interface. The gNB may forward the received remote-relay flow mapping information to the relay UE/the remote UE, i.e. receiving the mapping information from remote UE and forwarding to the relay UE or vice versa, so that both relay UE and the remote UE may have the same remote-relay flow mapping information.

According to certain example embodiments, the remote UE or the relay UE, or both the relay UE and the remote UE may transmit the remote-relay flow mapping information to the gNB. The remote-relay flow mapping information may include a mapping between an E2E RB ID, which may be defined by a gNB in a 3GPP side, and a flow ID over a non-3GPP remote-relay link. The flow may refer to any kind of logical channel used for transmission/reception of data from/to an RB over a remote-relay link.

In some example embodiments, transmission of the remote-relay flow mapping information may be performed based on satisfaction of a trigger condition of the transmission of the remote-relay flow mapping information. According to certain example embodiments, the trigger condition may include establishment of the link between the remote UE and the relay UE, or when the existing relay UE needs to be released and changed to a new relay UE. In addition, the trigger condition may be when the remote-relay flow mapping information is newly setup or modified. In some example embodiments, the remote-relay flow mapping information may be modified when an RB is newly added or released over an indirect path. Additionally, the trigger condition may be when the gNB requests the remote UE or the relay UE, or both the remote UE and the relay UE to send the remote-relay flow mapping information to the gNB. In other example embodiments, the trigger condition may be configured by the gNB to the remote UE and/or the relay UE.

According to certain example embodiments, the gNB may enable/disable transmission of the remote-relay flow mapping information. According to some example embodiments, enabling/disabling transmission of the remote-relay flow mapping information may be configured by the gNB through RRC signaling. If enabled, the remote UE or the relay UE or both may transmit the remote-relay flow mapping information to the gNB when the trigger condition is met. If disabled, the remote UE or the relay UE does not check whether the condition is met or not, or the remote UE or the relay UE does not transmit the remote-relay flow mapping information to the gNB. In some example embodiments, transmission of the remote-relay flow mapping information may be enabled to only one of the remote UE or the relay UE, or to both of the remote UE and the relay UE. This may be achieved by a separate RRC configuration to the remote UE and/or the relay UE indicating which node sends the remote-relay flow mapping information, and controls the transmission of the remote-relay flow mapping information by an enabling/disabling configuration. According to certain example embodiments, when both UEs are configured to send the remote-relay flow mapping information to the gNB, the gNB may store the latest one among the received information from both UEs. Or the gNB may compare the remote-relay flow mapping information received from the relay UE and the remote UE and indicate the non-matched flow mapping information to the relay UE and the remote UE if the mismatch is identified. The transmission of the remote-relay flow mapping information may be enabled to the remote UE or the relay UE on one direction mapping information, respectively. For instance, the transmission of the remote-relay flow mapping information for the UL traffic may be enabled to the remote UE, and for the DL traffic may be enabled to the relay UE.

In certain example embodiments, the remote UE or the relay UE may transmit the remote-relay flow mapping information in a RRC container. The RRC container may be used regardless of which protocol is assumed over the remote-relay link. The contents of the container may be transparent data from the gNB (i.e., the gNB is not expected to have the ability to interpret or modify the transparent data). According to certain example embodiments, the RRC container may correspond to RRC information that the transmitting entity generated, but may not usually be decoded by the receiving entity. The RRC container may be forwarded to a third entity by the receiving entity. In the present example, the relay UE may generate the remote-relay mapping information and put it in the RRC container to send to the gNB. The gNB may then forward the RRC container to the remote UE or vice versa.

According to certain example embodiments, the gNB may send the stored remote-relay flow mapping information to the remote UE or the relay UE when the remote UE or the relay UE requests it, or immediately when the gNB receives it from either UE. The latter may be considered as the exchange of the remote-relay flow mapping information via the gNB instead of via the remote-relay link. Alternatively, the gNB may deliver the stored remote-relay flow mapping information to a target relay UE after successfully changing a relay UE of the remote UE. For example, it may be when the gNB receives an RRC message indicating a reconfiguration complete or setup complete regarding the remote-relay link, or during the change of the relay UE of the remote UE (e.g., when the gNB sends a RRC reconfiguration message to the remote UE or the relay UE). The gNB may also deliver the stored remote-relay flow mapping information in an RRC container.

In other example embodiments, when the gNB transmits the stored remote-relay flow mapping information, the gNB may determine whether to send it to either the remote UE or the relay UE, or to both the remote UE and the relay UE. The gNB may also determine whether to send all the stored remote-relay flow mapping information or a portion of it. For example, the gNB may send the stored information received from the remote UE to the relay UE only, and the stored information received from the relay UE to the remote UE. Depending on the trigger condition (e.g., targe relay is changed), the gNB may send the stored remote-relay flow mapping information to both the remote UE and the relay UE.

According to certain example embodiments, if the remote UE or the relay UE receives the remote-relay flow mapping information from the gNB, the remote UE or the relay UE may use the remote-relay link for mapping in a bearer mapping procedure when transmitting or receiving data over a remote-relay link. For example, since the flow mapping information indicates how the remote UE's E2E bearer is mapped to the remote-relay flow, this mapping information may indicate the relay/remote UE which remote-relay flow is used for transmitting the data of the given E2E bearer of the remote UE.

In certain example embodiments, if the gNB receives the remote-relay flow mapping information from a remote UE or a relay UE, the gNB may determine that the remote-relay link is operating based on the non-3GPP interface, and may perform a corresponding behavior such as providing a necessary configuration (e.g., only 1:1 mapping of remote UE's E2E bearer to the remote UE's Uu RLC channel) for scenario 2 or selection of a proper relay for scenario 2.

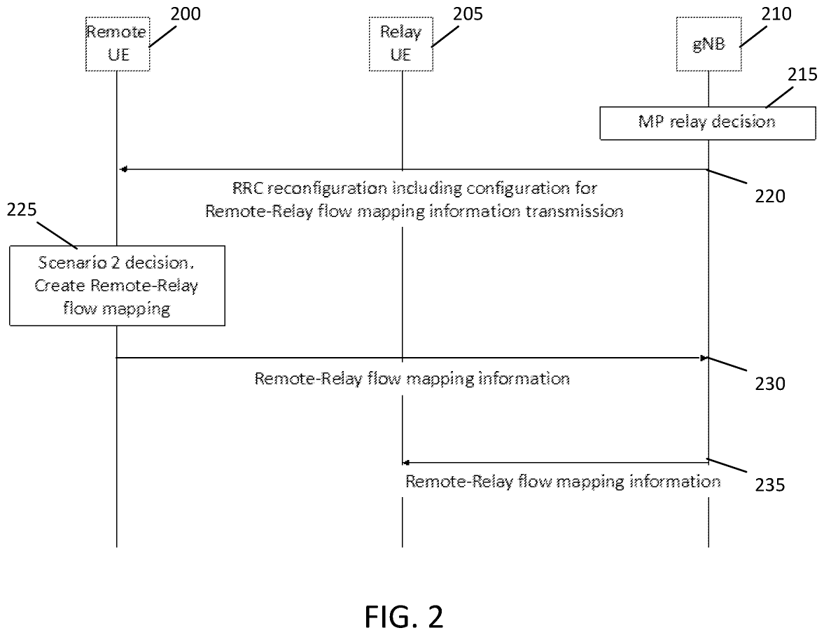

FIG. 2 illustrates an example signal diagram, according to certain example embodiments. As illustrated in FIG. 2, the remote-relay flow mapping information may be determined by the remote UE and transmit the decision to the relay UE 205 via the gNB 210. At 215, the gNB 210 may make a multipath (MP) relay decision. At 220, the gNB 210 may transmit an RRC reconfiguration message to the remote UE 200. The RRC reconfiguration message may include configuration for remote-relay flow mapping information transmission by the remote UE 200. At 225, the remote UE 200 may create the remote-relay flow mapping information. At 230, the remote UE 200 may transmit the remote-relay flow mapping information to the gNB 210. At 235, the gNB 210 may forward the remote-relay flow mapping information received from the remote UE 200 to the relay UE 205.

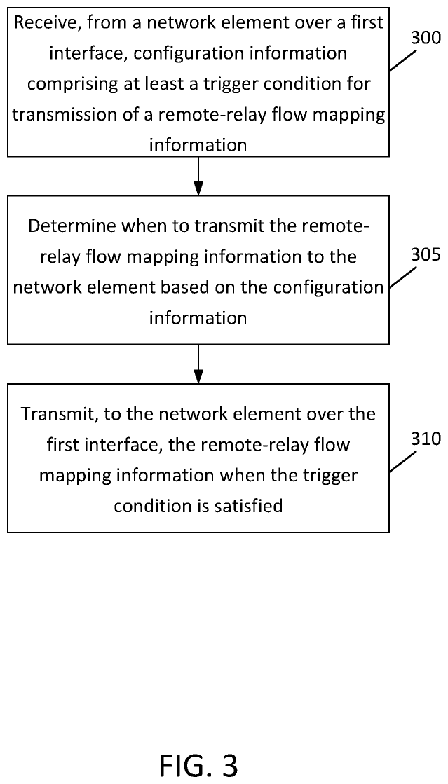

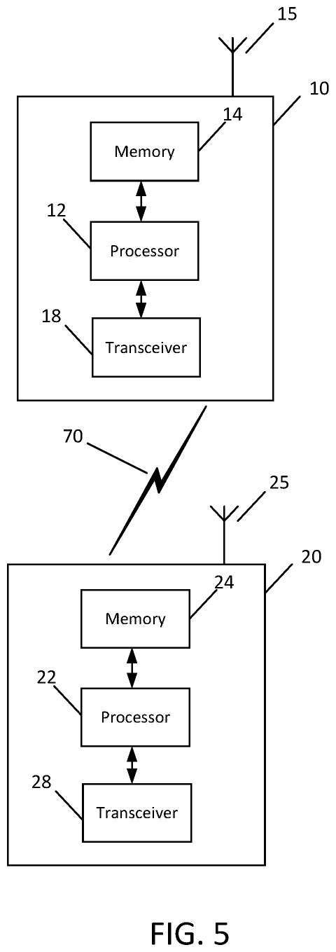

FIG. 3 illustrates an example flow diagram of a method, according to certain example embodiments. In an example embodiment, the method of FIG. 3 may be performed by, for example, a UE (e.g., relay UE and/or remote UE) similar to one of apparatuses 10 or 20 illustrated in FIG. 5.

According to certain example embodiments, the method of FIG. 3 may include, at 300, receiving, from a network element over a first interface, configuration information comprising at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The method may also include, at 305, determining when to transmit the remote-relay flow mapping information to the network element based on the configuration information. The method may further include, at 310, transmitting, to the network element over the first interface, the remote-relay flow mapping information when the trigger condition is satisfied.

According to certain example embodiments, the first interface may utilize a 3^{rd} generation partnership project interface, and the second interface utilizes a non-3^{rd} generation partnership project interface. According to some example embodiments, the flow identifier may be associated with a logical channel used for transmission or reception of data to or from a bearer over the second interface. In some example embodiments, the bearer over the first interface may be a radio bearer. According to other example embodiments, the trigger condition may be configured by the network element, and the trigger condition takes place when establishment of a link over the second interface between a first user equipment and a second user equipment, release of the link over the second interface between the first user equipment and the second user equipment, or change the link over the second interface between the first user equipment from the second user equipment to a new user equipment.

In certain example embodiments, the first user equipment may be a remote user equipment or a relay user equipment, the second user equipment may be the relay user equipment when the first user equipment is the remote user equipment, otherwise, the second user equipment is the remote user equipment when the first user equipment is the relay user equipment, and the new user equipment may be another relay user equipment. In some example embodiments, the method may further include receiving, from the network element, stored remote-relay flow mapping information. In other example embodiments, the remote-relay flow mapping information may be transmitted to the network element when the first user equipment is the remote user equipment or the relay user equipment.

According to certain example embodiments, the remote-relay flow mapping information may be transmitted in a radio resource control container of the first interface. According to some example embodiments, the method may further include requesting the network element to transmit the remote-relay flow mapping information to the first user equipment. According to other example embodiments, the method may further include receiving, from the network element, the remote-relay flow mapping information. In addition, according to certain example embodiments, the method may include applying the remote-relay flow mapping information in a bearer mapping procedure when transmitting or receiving data over a remote-relay link in the second interface. In other example embodiments, the method may also include receiving configuration from the network element to enable or disable transmission of the remote-relay flow mapping information over the first interface.

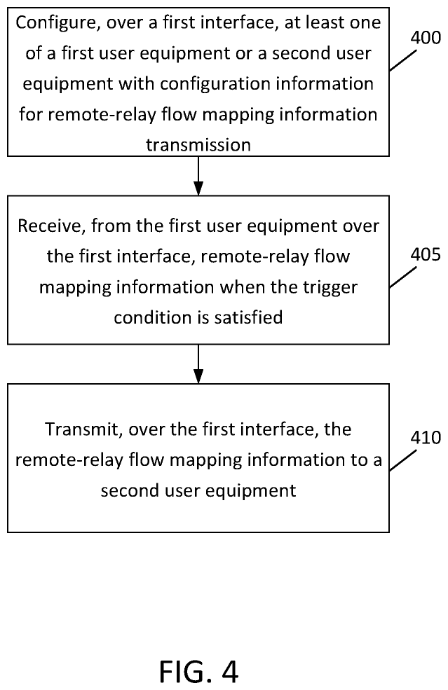

FIG. 4 illustrates an example of a flow diagram of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a network, cell, gNB, LMF, or any other device similar to one of apparatuses 10 or 20 illustrated in FIG. 5.

According to certain example embodiments, the method of FIG. 4 may include, at 400, configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information, the remote-relay flow mapping information may include a mapping between an end-to-end bearer identifier of the first interface and a flow identifier of a second interface, and the first interface and the second interface may each utilize different protocols. The method may also include, at 405, receiving, from the first user equipment over the first interface, remote-relay flow mapping information when the trigger condition is satisfied. The method may further include, at 410, transmitting, over the first interface, the remote-relay flow mapping information to a second UE.

According to certain example embodiments, the first user equipment may be a remote user equipment or a relay user equipment. According to some example embodiments, the second user equipment may be the relay user equipment when the first user equipment is a remote user equipment, otherwise the second user equipment may be the remote user equipment when the first user equipment is the relay user equipment. According to other example embodiments, the first interface may utilize a 3^{rd} generation partnership project interface, and the second interface may utilize a non-3^{rd} generation partnership project interface.

In certain example embodiments, the flow identifier may be associated with a logical channel used for transmission or reception of data to or from a radio bearer over the second interface.

According to certain example embodiments, the trigger condition may be configured by a network element, and the trigger condition takes place when establishment of a link over the second interface between the first user equipment and the second user equipment, release of the link over the second interface between the first user equipment and the second user equipment, change the link over the second interface between the first user equipment and the second user equipment to a new user equipment. According to some example embodiments, the method may also include transmitting, to the first user equipment or the second user equipment, stored remote-relay flow mapping information. According to other example embodiments, the remote-relay mapping information may be received and transmitted in a radio resource control container of the first interface.

In certain example embodiments, the method may further include receiving a request from the first user equipment or the second user equipment to transmit the remote-relay flow mapping information. In some example embodiments, the method may also include enabling or disabling transmission of the remote-relay flow mapping information by the first user equipment or the second user equipment. In other example embodiments, enabling transmission of the remote-relay flow mapping information may be applicable to one of the first user equipment or the second user equipment, or to both the first user equipment and the second user equipment. In further example embodiments, the method may also include transmitting the remote-relay flow mapping information to the second user equipment when the remote-relay flow mapping information is received from the first user equipment, transmitting the remote-relay flow mapping information to the first user equipment when the remote-relay flow mapping information is received from the second user equipment, or transmitting the remote-relay flow mapping information to a new user equipment. In other example embodiments, the method may further include determining that a remote-relay link is operating based on a non-3^{rd} generation partnership project interface, and providing a necessary configuration or a selection of a proper relay to the first user equipment or the second user equipment.

In certain example embodiments, apparatus 10 may include at least one processor 12, and at least one memory 14 including computer program code. The at least one memory 14 and the computer program code may be configured to, with storing instructions that, when executed by the at least one processor 12, cause the apparatus 10 to receive, from a network element over a first interface, configuration information including at least a trigger condition for transmission of a remote-relay flow mapping information (e.g., step 220 in FIG. 2). The remote-relay flow mapping information may include a mapping between an end-to-end bearer identifier of the first interface and a flow identifier of a second interface, and the first interface and the second interface may each utilize different protocols. According to other example embodiments, the apparatus 10 may also be caused to determine when to transmit the remote-relay flow mapping information to the network element based on the configuration information (e.g., step 225 in FIG. 2). According to further example embodiments, the apparatus 10 may further be caused to transmit, to the network element over the first interface, the remote-relay flow mapping information when the trigger condition is satisfied (e.g., step 230 in FIG. 2).

According to certain example embodiments, the first interface may utilize a 3^{rd} generation partnership project interface, and the second interface may utilize a non-3^{rd} generation partnership project interface. According to some example embodiments, the flow identifier may be associated with a logical channel used for transmission or reception of data to or from a bearer over the second interface. According to other example embodiments, the trigger condition may be configured by the network element, and the trigger condition takes place when establishment of a link over the second interface between the apparatus and a user equipment, release of the link over the second interface between the apparatus and the user equipment, or change the link over the second interface between the apparatus from the user equipment to a new user equipment.

In certain example embodiments, the apparatus is a remote user equipment or a relay user equipment, the user equipment is the relay user equipment when the apparatus is the remote user equipment, otherwise, the user equipment is the remote user equipment when the apparatus is the relay user equipment, and the new user equipment is another relay user equipment (e.g., 200 and 205 in FIG. 2). In some example embodiments, apparatus 10 may also be caused to receive, from the network element, stored remote-relay flow mapping information (e.g., step 235 in FIG. 2). In other example embodiments, the remote-relay flow mapping information may be transmitted to the network element when the apparatus is the remote user equipment or the relay user equipment (e.g., step 230 in FIG. 2). In further example embodiments, the remote-relay flow mapping information may be transmitted in a radio resource control container of the first interface.

According to certain example embodiments, apparatus 10 may further be caused to request the network element to transmit the remote-relay flow mapping information to the apparatus. According to some example embodiments, the apparatus 10 may be caused to receive, from the network element, the remote-relay flow mapping information (e.g., step 235 in FIG. 2). According to other example embodiments, the apparatus 10 may also be caused to apply the remote-relay flow mapping information in a bearer mapping procedure when transmitting or receiving data over a remote-relay link in the second interface. According to further example embodiments, the apparatus 10 may be caused to receive configuration from the network element to enable or disable transmission of the remote-relay flow mapping information over the first interface (e.g., step 220 in FIG. 2).

In certain example embodiments, apparatus 20 may include at least one processor 22, and at least one memory 24 including computer program code. The at least one memory 24 and the computer program code may be configured to, with storing instructions that, when executed by the at least one processor 22, cause the apparatus 20 to configure, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. According to other example embodiments, the apparatus 20 may also be caused to receive, from the first user equipment over the first interface, remote-relay flow mapping information when the trigger condition is satisfied. According to further example embodiments, the apparatus 20 may further be caused to transmit, over the first interface, the remote-relay flow mapping information to a second user equipment.

In certain example embodiments, the first user equipment is a remote user equipment or a relay user equipment (e.g., 200 and 205 in FIG. 2). In some example embodiments, the second user equipment is the relay user equipment when the first user equipment is a remote user equipment, otherwise the second user equipment is the remote user equipment when the first equipment is the relay user equipment (e.g., 200 and 205 in FIG. 2). In other example embodiments, the first interface utilizes a 3^{rd} generation partnership project interface, and the second interface utilizes a non-3^{rd} generation partnership project interface. In further example embodiments, the flow identifier may be associated with a logical channel used for transmission or reception of data to or from a radio bearer over the second interface.

According to certain example embodiments, the trigger condition is configured by the apparatus, and the trigger condition takes place when, establishment of a link over the second interface between the first user equipment and the second user equipment, release of the link over the second interface between the first user equipment and the second user equipment, or change the link over the second interface between the first user equipment and the second user equipment to a new user equipment.

In certain example embodiments, the apparatus 20 may also be caused to transmit, to the first user equipment or the second user equipment, stored remote-relay flow mapping information (e.g., step 235 in FIG. 2). In some example embodiments, the remote-relay mapping information is received and transmitted in a radio resource control container of the first interface. In other example embodiments, the apparatus 20 may further be caused to receive a request from the first user equipment or the second user equipment to transmit the remote-relay flow mapping information. In further example embodiments, the apparatus 20 may be caused to enable or disable transmission of the remote-relay flow mapping information by the first user equipment or the second user equipment (e.g., step 220 in FIG. 2).

According to certain example embodiments, enabling transmission of the remote-relay flow mapping information is applicable to one of the first user equipment or the second user equipment, to both the first user equipment and the second user equipment (e.g., 200 and 205 in FIG. 2). According to some example embodiments, the apparatus 20 may also be caused to transmit the remote-relay flow mapping information to the second user equipment when the remote-relay flow mapping information is received from the first user equipment, transmit the remote-relay flow mapping information to the first user equipment when the remote-relay flow mapping information is received from the second user equipment, or transmit the remote-relay flow mapping information to a new user equipment (e.g., step 235 in FIG. 2). According to other example embodiments, the apparatus 20 may also be caused to determine that a remote-relay link is operating based on a non-3^{rd} generation partnership project interface, and provide a necessary configuration or a selection of a proper relay to the first user equipment or the second user equipment (e.g., step 220 in FIG. 2).

FIG. 5 illustrates a set of apparatuses 10 and 20 according to certain example embodiments. In certain example embodiments, the apparatus 10 may be an element in a communications network or associated with such a network, such as a UE (e.g., relay UE and/or transmit UE), mobile equipment (ME), mobile station, mobile device, stationary device, IoT device, or other device. It should be noted that one of ordinary skill in the art would understand that apparatus 10 may include components or features not shown in FIG. 5.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5.

As illustrated in the example of FIG. 5, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-3.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that

provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element over a first interface, configuration information including at least a trigger condition for transmission of a remote-relay flow mapping information. According to certain example embodiments, the remote-relay flow mapping information comprises a mapping between an end-to-end bearer identifier of the first interface and a flow identifier of a second interface, and the first interface and the second interface may each utilize different protocols. Apparatus 10 may also be controlled by memory 14 and processor 12 to transmit, to the network element over the first interface, the remote-relay flow mapping information when the trigger condition is satisfied.

As illustrated in the example of FIG. 5, apparatus 20 may be a network, core network element, or element in a communications network or associated with such a network, such as a gNB, LMF, BS, cell, or NW. It should be noted that one of ordinary skill in the art would understand that apparatus 20 may include components or features not shown in FIG. 5.

As illustrated in the example of FIG. 5, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1, 2, and 4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1, 2, and 4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to configure, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. Apparatus 20 may also be controlled by memory 24 and processor 22 to receive, from the first user equipment over the first interface, remote-relay flow mapping information when the trigger condition is satisfied. Apparatus 20 may further be controlled by memory 24 and processor 22 to transmit, over the first interface, the remote-relay flow mapping information to a second user equipment.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a network element over a first interface, configuration information including at least a trigger condition for transmission of a remote-relay flow mapping information. According to certain example embodiments, the remote-relay flow mapping information may include a mapping between an end-to-end bearer identifier of the first interface and a flow identifier of a second interface, and the first interface and the second interface may each utilize different protocols. The apparatus may also include means for determining when to transmit the remote-relay flow mapping information to the network element based on the configuration information. The apparatus may further include means for transmitting, to the network element over the first interface, the remote-relay flow mapping information when the trigger condition is satisfied.

Certain example embodiments may also be directed to an apparatus that includes means for configuring, over a first interface, at least one of a first user equipment or a second user equipment with configuration information for remote-relay flow mapping information transmission. According to certain example embodiments, the configuration information may include at least a trigger condition for transmission of the remote-relay flow mapping information. The remote-relay flow mapping information may include a mapping between an end-to-end bearer identifier of the first interface and a flow identifier of a second interface, and the first interface and the second interface may each utilize different protocols. The apparatus may also include means for receiving, from the first user equipment over the first interface, remote-relay flow mapping information when the trigger condition is satisfied. The apparatus may further include means for transmitting, over the first interface, the remote-relay flow mapping information to a second user equipment.

Certain example embodiments described herein provide several technical improvements, enhancements, and/or advantages. For instance, in some example embodiments, it may be possible to provide a mechanism to deliver the remote-relay flow ID mapping information via the gNB when the delivery of the remote-relay flow ID mapping information over second interface is not possible. In some example embodiment, it enables faster remote-relay flow ID mapping information delivery to a new relay UE when the remote UE switches the current serving relay UE to the new relay UE

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:
3GPP 3rd Generation Partnership Project
5G 5th Generation
5GCN 5G Core Network
5GS 5G System
BS Base Station
BW Bandwidth
E2E End-to-End
eNB Enhanced Node B
gNB 5G or Next Generation NodeB
LTE Long Term Evolution
NR New Radio
NRPPa New Radio Positioning Protocol a
NW Network
RB Radio Bearer
RRC Radio Resource Control
SL Sidelink
UE User Equipment
UL Uplink

We claim:

1. An apparatus, comprising:
at least one processor; and
at least one memory storing instructions that, when executed by the at least one processor, cause the apparatus at least to:
receive, from a network element over a first interface, configuration informations comprising at least a trigger condition for transmission of a remote-relay flow mapping information, wherein the remote-relay flow mapping information comprises a mapping between an end-to-end bearer identifier of the first interface and a flow identifier of a second interface, and wherein the first interface and the second interface each utilizes different protocols;
determine when to transmit the remote-relay flow mapping transmit, to the network element over the first interface, the remote-relay flow mapping information when the trigger condition is satisfied.

2. The apparatus according to claim 1, wherein the first interface utilizes a 3rd generation partnership project interface, and the second interface utilizes a non-3rd generation partnership project interface.

3. The apparatus according to claim 1, wherein the flow identifier is associated with a logical channel used for transmission or reception of data to or from a bearer over the second interface.

4. The apparatus according to claim 1, wherein the trigger condition is configured by the network element, and the trigger condition takes place when:
establishment of a link over the second interface between the apparatus and a user equipment,
release of the link over the second interface between the apparatus and the user equipment, or
change the link over the second interface between the apparatus from the user equipment to a new user equipment.

5. The apparatus according to claim 1,
wherein the apparatus is a remote user equipment or a relay user equipment,
wherein the user equipment is the relay user equipment when the apparatus is the remote user equipment, otherwise, the user equipment is the remote user equipment when the apparatus is the relay user equipment, and
wherein the new user equipment is another relay user equipment.

6. The apparatus according to claim 5, wherein the apparatus is further configured to:
receive, from the network element, stored remote-relay flow mapping information.

7. The apparatus according to claim 5, wherein the remote-relay flow mapping information is transmitted to the network element when the apparatus is the remote user equipment or the relay user equipment.

8. The apparatus according to claim 1, wherein the remote-relay flow mapping information is transmitted in a radio resource control container of the first interface.

9. The apparatus according to claim 1, further caused to:
request the network element to transmit the remote-relay flow mapping information to the apparatus.

10. The apparatus according to claim 1, further caused to:
receive, from the network element, the remote-relay flow mapping information.

11. The apparatus according to claim 1, further caused to:
apply the remote-relay flow mapping information in a bearer mapping procedure when transmitting or receiving data over a remote-relay link in the second interface.

12. The apparatus according to claim 1, further caused to:
receive configuration from the network element to enable or disable transmission of the remote-relay flow mapping information over the first interface.

13. An apparatus, comprising:
at least one processor; and
at least one memory storing instructions that, when executed by the at least one processor, cause the apparatus at least to:
configure, over a first interface, at least one of a first user equipment or a second user equipment with configuration information for remote-relay flow mapping information transmission, wherein the configuration information comprises at least a trigger condition for transmission of the remote-relay flow mapping information, wherein the remote-relay flow mapping information comprises a mapping between an end-to-end bearer identifier of the first interface and a flow identifier of a second interface, and wherein the first interface and the second interface each utilizes different protocols; and
receive, from the first user equipment over the first interface, remote-relay flow mapping information when the trigger condition is satisfied; and
transmit, over the first interface, the remote-relay flow mapping information to the second user equipment.

14. The apparatus according to claim 13, wherein the first user equipment is a remote user equipment or a relay user equipment.

15. The apparatus according to claim 13, wherein the second user equipment is the relay user equipment when the first user equipment is a remote user equipment, otherwise the second user equipment is the remote user equipment when the first equipment is the relay user equipment.

16. The apparatus according to claim 13, wherein the first interface utilizes a 3rd generation partnership project interface, and the second interface utilizes a non-3rd generation partnership project interface.

17. The apparatus according to claim 13, wherein the flow identifier is associated with a logical channel used for transmission or reception of data to or from a radio bearer over the second interface.

18. The apparatus according to claim 13, wherein the trigger condition is configured by the apparatus, and the trigger condition takes place when:
establishment of a link over the second interface between the first user equipment and the second user equipment,
release of the link over the second interface between the first user equipment and the second user equipment, or
change the link over the second interface between the first user equipment and the second user equipment to a new user equipment.

19. The apparatus according to 13, further caused to:
transmit, to the first user equipment or the second user equipment, stored remote-relay flow mapping information.

20. The apparatus according to claim 13, wherein the remote-relay mapping information is received in a radio resource control container of the first interface.
